(19) United States
(12) Patent Application Publication
(10) Pub. No.: US 2019/0221363 A1
(43) Pub. Date: Jul. 18, 2019

(54) WIRELESS CHARGING PAD INCOPORATING FERRITE OF VARIOUS STRUCTURES IN WIRELESS POWER TRANSFER SYSTEM FOR ELECTRIC VEHICLE

(71) Applicants: HYUNDAI MOTOR COMPANY, Seoul (KR); KIA MOTORS CORPORATION, Seoul (KR); RESEARCH & BUSINESS FOUNDATION SUNGKYUNKWAN UNIVERSITY, Suwon-si, (KR)

(72) Inventors: Gyu Yeong CHOE, Suwon-si (KR); Jae Eun CHA, Gwangmyeong-si (KR); Woo Young LEE, Yongin-si (KR); Dong Sup AHN, Seoul (KR); Byoung Kuk LEE, Yongin-si (KR); Min Kook KIM, Suwon-si (KR); Jong Eun BYUN, Suwon-si (KR); Sang Joon ANN, Suwon-si (KR)

(21) Appl. No.: 16/205,668

(22) Filed: Nov. 30, 2018

(30) Foreign Application Priority Data
Jan. 17, 2018 (KR) 10-2018-0005940

(51) Int. Cl. H01F 38/14; H02J 7/02; H02J 50/12

(52) U.S. Cl. CPC H01F 38/14; H02J 7/025; H01F 27/36; H02J 50/12; B60L 11/182

(57) ABSTRACT

A wireless charging pad for transferring wireless power to an electric vehicle (EV) may comprise a plate type ferrite; and a coil disposed on an upper part of the plate type ferrite, the plate type ferrite may comprise a first ferrite member occupying an inside of a region defined by an inner surface of the coil and a second ferrite member occupying an outside of a region defined by an outer surface of the coil, and the second ferrite member has a wall shape surrounding the outer surface of the coil. Accordingly, safety can be improved by using the ferrite structure having excellent EMI characteristics in the wireless recharging pad, and the WPT efficiency can also be enhanced by using the ferrite structure having excellent electromagnetic characteristics in the wireless charging pad.

### CROSS-REFERENCE TO RELATED APPLICATIONS

The present application claims the benefit of priority to Korean Patent Application No. 10-2018-0005940, filed on Jan. 17, 2018 in the Korean Intellectual Property Office (KIPO), the entire contents of both of which are incorporated herein by reference.

### TECHNICAL FIELD

The present disclosure relates to a wireless charging pad for an electric vehicle (EV) wireless power transfer (WPT) system, in which ferrite of various structures is incorporated, and more specifically, to a technique for grasping electrical characteristics varying according to a structure of ferrite built in a transmission pad and a reception pad used in the EV WPT system, and applying ferrite of various structures to the transmission pad or the reception pad based on the grasped electrical characteristics.

### BACKGROUND

An electric vehicle (EV) charging system may be defined as a system for charging a high-voltage battery mounted in an EV using power of an energy storage device or a power grid of a commercial power source. The EV charging system may have various forms according to the type of EV. For example, the EV charging system may be classified as a conductive-type using a charging cable or a non-contact wireless power transfer (WPT)-type (also referred to as an “inductive-type”).

When charging an EV wirelessly, a reception coil in a vehicle assembly (VA) mounted in the EV forms an inductive resonant coupling with a transmission coil in a group assembly (GA) located in a charging station or a charging spot. Electric power is then transferred from the GA to the VA to charge the high-voltage battery of the EV through the inductive resonant coupling.

Meanwhile, in order to secure power transfer efficiency in the inductive-type WPT system, the structure of the transmission pad and the reception pad is an important factor.

Particularly, the transmission pad and the reception pad have a built-in ferrite, which is a magnetic substance that assists the WPT. The structure of ferrite may change the power transfer efficiency and the degree of electromagnetic exposure to the user. Therefore, there is a need to establish a ferrite structure for enhancing the power transfer efficiency in the WPT system and ensuring user safety.

### SUMMARY

Embodiments of the present disclosure provide a wireless charging pad for transferring wireless power to an EV by using ferrite of various structures.

According to embodiments of the present disclosure, a wireless charging pad for transferring wireless power to an electric vehicle (EV) may comprise a plate type ferrite; and a coil disposed on an upper part of the plate type ferrite, wherein the plate type ferrite comprises a first ferrite member occupying an inside of a region defined by an inner surface of the coil and a second ferrite member occupying an outside of a region defined by an outer surface of the coil, and the first ferrite member has a protruding portion facing the inner surface of the coil.

The wireless charging pad may further comprise a flat plate type aluminum shield disposed in a lower part of the plate type ferrite.

The coil may have a uniform spacing with the protruding portion of the first ferrite member and an outer surface of the second ferrite member.

Furthermore, in accordance with embodiments of the present disclosure, a wireless charging pad for transferring wireless power to an electric vehicle (EV) may comprise a plate type ferrite; and a coil disposed on an upper part of the plate type ferrite, wherein the plate type ferrite comprises a first ferrite member occupying an inside of a region defined by an inner surface of the coil and a second ferrite member occupying an outside of a region defined by an outer surface of the coil, and the second ferrite member has a wall shape surrounding the outer surface of the coil.

A width between the inner surface of the coil and the outer surface of the coil may be 60 millimeters.

Furthermore, in accordance with embodiments of the present disclosure, a wireless charging pad for transferring wireless power to an electric vehicle (EV) may comprise a plate type ferrite; and a coil disposed on an upper part of the plate type ferrite, wherein the plate type ferrite comprises a first ferrite member occupying an inside of a region defined by an inner surface of the coil and a second ferrite member occupying an outside of a region defined by an outer surface of the coil, and the first ferrite member comprises a groove at a central portion of the first ferrite member.

The first ferrite member may have a wall shape surrounded by the inner surface of the coil in between a boundary of the groove and the inner surface of the coil.

The second ferrite member may have a wall shape surrounding the outer surface of the coil.

The coil may be arranged so that an outer surface of the plate type ferrite and the outer surface of the coil are on a same vertical plane.

The coil may have a uniform spacing with an outer surface of the plate type ferrite and a boundary of the groove.

The coil may be arranged so that a boundary of the groove and the inner surface of the coil are on a same vertical plane.

The wireless charging pad may be a transmission pad for transferring wireless power to a reception pad equipped in the EV.

The wireless charging pad may further comprise a flat plate type aluminum shield disposed in a lower part of the plate type ferrite.

A width between the inner surface of the coil and the outer surface of the coil may be 60 millimeters.

In the WPT system for EV according to the present disclosure as described above, the wireless charging pad with the optimal ferrite structure can be provided considering changes in the electromagnetic characteristics and the electromagnetic interference (EMI) characteristics. Accordingly, safety can be improved by using the ferrite structure having excellent EMI characteristics in the wireless recharging pad, and the WPT efficiency can also be enhanced by using the ferrite structure having excellent electromagnetic characteristics in the wireless charging pad.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a concept of a wireless power transfer (WPT) to which embodiments of the present disclosure are applied;

FIG. 2 is a conceptual diagram illustrating a WPT circuit according to embodiments of the present disclosure;

FIG. 3 is a conceptual diagram for explaining a concept of alignment in an EV WPT according to embodiments of the present disclosure;

FIG. 4 is a diagram illustrating a cross-sectional view and an elevation view of a transmission pad according to an embodiment of the present disclosure;

FIG. 5 is a diagram illustrating a cross-sectional view and an elevation view of a reception pad according to an embodiment of the present disclosure;

FIG. 6 is an exemplary view illustrating ferrite structures applicable to a transmission pad and a reception pad according to embodiments of the present disclosure;

FIG. 7A is a graph illustrating a change in magnetic inductance due to x-axis separation between a transmission pad and a reception pad to which various ferrite structures according to embodiments of the present disclosure are applied;

FIG. 7B is a graph illustrating a change in magnetic inductance due to y-axis separation between a transmission pad and a reception pad to which various ferrite structures according to embodiments of the present disclosure are applied;

FIG. 8A is a graph illustrating a change in coupling coefficient due to x-axis separation between a transmission pad and a reception pad to which various ferrite structures according to embodiments of the present disclosure are applied;

FIG. 8B is a graph illustrating a change in coupling coefficient due to y-axis separation between a transmission pad and a reception pad to which various ferrite structures according to embodiments of the present disclosure are applied;

FIG. 9 is an exemplary view illustrating magnetic flux density distributions formed between a transmission pad and a reception pad to which various ferrite structures according to embodiments of the present disclosure are applied;

FIGS. 10A and 10B are diagrams illustrating an experimental environment in which EMI is evaluated using a transmission pad to which various ferrite structures are applied according to embodiments of the present disclosure; and

FIGS. 11A to 11C are diagrams illustrating ferrite structures obtained by subdividing the ferrite structure according to the fourth embodiment of FIG. 6 by the relative positions of the coils and the ferrite.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein. While describing the respective drawings, like reference numerals designate like elements.

It will be understood that although the terms “first,” “second,” etc. may be used herein to describe various components, these components should not be limited by these terms. These terms are used merely to distinguish one element from another. For example, without departing from the scope of the present disclosure, a first component may be designated as a second component, and similarly, the second component may be designated as the first component. The term “and/or” include any and all combinations of one of the associated listed items.

It will be understood that when a component is referred to as being “connected to” another component, it can be directly or indirectly connected to the other component. That is, for example, intervening components may be present. On the contrary, when a component is referred to as being “directly connected to” another component, it will be understood that there is no intervening components.

Terms are used herein only to describe the embodiments but not to limit the present disclosure. Singular expressions, unless defined otherwise in contexts, include plural expressions. In the present specification, terms of “comprise” or “have” are used to designate features, numbers, steps, operations, elements, components or combinations thereof disclosed in the specification as being present but not to exclude possibility of the existence or the addition of one or more other features, numbers, steps, operations, elements, components, or combinations thereof.

All terms including technical or scientific terms, unless being defined otherwise, have the same meaning generally understood by a person of ordinary skill in the art. It will be understood that terms defined in dictionaries generally used are interpreted as including meanings identical to contextual meanings of the related art, unless definitely defined otherwise in the present specification, are not interpreted as being ideal or excessively formal meanings.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, devices, or the like, as described herein. Moreover, it is understood that the below methods may be executed by an apparatus comprising the controller in conjunction with one or more other components, as would be appreciated by a person of ordinary skill in the art.

According to embodiments of the present disclosure, an EV charging system may be defined as a system for charging a high-voltage battery mounted on an EV using power of an energy storage device or a power grid of a commercial power source. The EV charging system may have various forms according to the type of EV. For example, the EV charging system may be classified as a conductive-type using a charging cable or a non-contact wireless power transfer (WPT)-type (also referred to as an “inductive-type”). The power source may include a residential or public electrical service or a generator utilizing vehicle- mounted fuel, and the like.

Terms used in the present disclosure are defined as follows.

“Electric Vehicle (EV)”: An automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be four or more wheeled vehicle manufactured for use primarily on public streets, roads.

The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

“Plug-in Electric Vehicle (PEV)”: An Electric Vehicle that recharges the on-vehicle primary battery by connecting to the power grid.

“Plug-in vehicle (PV)”: An electric vehicle rechargeable through wireless charging from an electric vehicle supply equipment (EVSE) without using a physical plug or a physical socket.

“Heavy duty vehicle (H.D. Vehicle)”: Any four-or more wheeled vehicle as defined in 49 CFR 523.6 or 49 CFR 37.3 (bus).

“Light duty plug-in electric vehicle”: A three or four-wheeled vehicle propelled by an electric motor drawing current from a rechargeable storage battery or other energy devices for use primarily on public streets, roads and highways and rated at less than 4,545 kg gross vehicle weight.

“Wireless power charging system (WCS)”: The system for wireless power transfer and control between the GA and VA including alignment and communications. This system transfers energy from the electric supply network to the electric vehicle electromagnetically through a two-part loosely coupled transformer.

“Wireless power transfer (WPT)”: The transfer of electrical power from the AC supply network to the electric vehicle by contactless means.

“Utility”: A set of systems which supply electrical energy and may include a customer information system (CIS), an advanced metering infrastructure (AMI), rates and revenue system, etc. The utility may provide the EV with energy through rates table and discrete events. Also, the utility may provide information about certification on EVs, interval of power consumption measurements, and tariff.

“Smart charging”: A system in which EVSE and/or PEV communicate with power grid in order to optimize charging ratio or discharging ratio of EV by reflecting capacity of the power grid or expense of use.

“Automatic charging”: A procedure in which inductive charging is automatically performed after a vehicle is located in a proper position corresponding to a primary charger assembly that can transfer power. The automatic charging may be performed after obtaining necessary authentication and right.

“Interoperability”: A state in which components of a system interwork with corresponding components of the system in order to perform operations aimed by the system. Also, information interoperability may mean capability that two or more networks, systems, devices, applications, or components can efficiently share and easily use information without causing inconvenience to users.

“Inductive charging system”: A system transferring energy from a power source to an EV through a two-part gapped core transformer in which the two halves of the transformer, primary and secondary coils, are physically separated from one another. In the present disclosure, the inductive charging system may correspond to an EV power transfer system.

“Inductive coupler”: The transformer formed by the coil in the GA Coil and the coil in the VA Coil that allows power to be transferred with galvanic isolation.

“Inductive coupling”: Magnetic coupling between two coils. In the present disclosure, coupling between the GA Coil and the VA Coil.

“Ground assembly (GA)”: An assembly on the infrastructure side consisting of the GA Coil, a power/frequency conversion unit and GA controller as well as the wiring from the grid and between each unit, filtering circuits, housing(s) etc., necessary to function as the power source of wireless power charging system. The GA may include the communication elements necessary for communication between the GA and the VA.

“Vehicle assembly (VA)”: An assembly on the vehicle consisting of the VA Coil, rectifier/power conversion unit and VA controller as well as the wiring to the vehicle batteries and between each unit, filtering circuits, housing(s), etc., necessary to function as the vehicle part of a wireless power charging system. The VA may include the communication elements necessary for communication between the VA and the GA.

The GA may be referred to as a primary device (PD), and the VA may be referred to as a secondary device (SD).

“Primary device”: An apparatus which provides the contactless coupling to the secondary device. That is, the primary device may be an apparatus external to an EV. When the EV is receiving power, the primary device may act as the source of the power to be transferred. The primary device may include the housing and all covers.

“Secondary device”: An apparatus mounted on the EV which provides the contactless coupling to the primary device. That is, the secondary device may be installed in the EV. When the EV is receiving power, the secondary device may transfer the power from the primary to the EV. The secondary device may include the housing and all covers.

“GA controller”: The portion of the GA which regulates the output power level to the GA Coil based on information from the vehicle.

“VA controller”: The portion of the VA that monitors specific on-vehicle parameters during charging and initiates communication with the GA to control output power level.

The GA controller may be referred to as a primary device communication controller (PDCC), and the VA controller may be referred to as an electric vehicle communication controller (EVCC).

“Magnetic gap”: The vertical distance between the plane of the higher of the top of the litz wire or the top of the magnetic material in the GA Coil to the plane of the lower of the bottom of the litz wire or the magnetic material in the VA Coil when aligned.

“Ambient temperature”: The ground-level temperature of the air measured at the subsystem under consideration and not in direct sun light.

“Vehicle ground clearance”: The vertical distance between the ground surface and the lowest part of the vehicle floor pan.

“Vehicle magnetic ground clearance”: The vertical distance between the plane of the lower of the bottom of the litz wire or the magnetic material in the VA Coil mounted on a vehicle to the ground surface.

“VA coil magnetic surface distance”: the distance between the plane of the nearest magnetic or conducting component surface to the lower exterior surface of the VA coil when mounted. This distance includes any protective coverings and additional items that may be packaged in the VA coil enclosure.

The VA coil may be referred to as a secondary coil, a vehicle coil, or a receive coil. Similarly, the GA coil may be referred to as a primary coil, or a transmit coil.

“Exposed conductive component”: A conductive component of electrical equipment (e.g., an electric vehicle) that may be touched and which is not normally energized but which may become energized in case of a fault.

“Hazardous live component”: A live component, which under certain conditions can give a harmful electric shock.

“Live component”: Any conductor or conductive component intended to be electrically energized in normal use.

“Direct contact”: Contact of persons with live components. (See IEC 61440)

“Indirect contact”: Contact of persons with exposed, conductive, and energized components made live by an insulation failure. (See IEC 61140)

“Alignment”: A process of finding the relative position of primary device to secondary device and/or finding the relative position of secondary device to primary device for the efficient power transfer that is specified. In the present disclosure, the alignment may direct to a fine positioning of the wireless power transfer system.

“Pairing”: A process by which a vehicle is correlated with the unique dedicated primary device, at which it is located and from which the power will be transferred. Pairing may include the process by which a VA controller and a GA controller of a charging spot are correlated. The correlation/association process may include the process of establishment of a relationship between two peer communication entities.

“Command and control communication”: The communication between the EV supply equipment and the EV exchanges information necessary to start, control and terminate the process of WPT.

“High level communication (HLC)”: HLC is a special kind of digital communication. HLC is necessary for additional services which are not covered by command & control communication. The data link of the HLC may use a power line communication (PLC), but it is not limited.

“Low power excitation (LPE)”: LPE means a technique of activating the primary device for the fine positioning and pairing so that the EV can detect the primary device, and vice versa.

“Service set identifier (SSID)”: SSID is a unique identifier consisting of 32-characters attached to a header of a packet transmitted on a wireless LAN. The SSID identifies the basic service set (BSS) to which the wireless device attempts to connect. The SSID distinguishes multiple wireless LANs. Therefore, all access points (APs) and all terminal/station devices that want to use a specific wireless LAN can use the same SSID. Devices that do not use a unique SSID are not able to join the BSS. Since the SSID is shown as plain text, it may not provide any security features to the network.

“Extended service set identifier (ESSID)”: ESSID is the name of the network to which one desires to connect. It is similar to SSID but can be a more extended concept.

“Basic service set identifier (BSSID)”: BSSID consisting of 48bits is used to distinguish a specific BSS. In the case of an infrastructure BSS network, the BSSID may be medium access control (MAC) of the AP equipment. For an independent BSS or ad hoc network, the BSSID can be generated with any value.

The charging station may comprise at least one GA and at least one GA controller configured to manage the at least one GA. The GA may comprise at least one wireless communication device. The charging station may mean a place having at least one GA, which is installed in home, office, public place, road, parking area, etc.

According to embodiments of the present disclosure, a “rapid charging” may refer to a method of directly converting AC power of a power system to DC power, and supplying the converted DC power to a battery mounted on an EV. Here, a voltage of the DC power may be DC 500 volts (V) or less.

According to embodiments of the present disclosure, a “slow charging” may refer to a method of charging a battery mounted on an EV using AC power supplied to a general home or workplace. An outlet in each home or workplace, or an outlet disposed in a charging stand may provide the AC power, and a voltage of the AC power may be AC 220V or less. Here, the EV may further include an on-board charger (OBC) which is a device configured for boosting the AC power for the slow charging, converting the AC power to DC power, and supplying the converted DC power to the battery.

Hereinafter, embodiments of the present disclosure will be explained in detail by referring to accompanying figures.

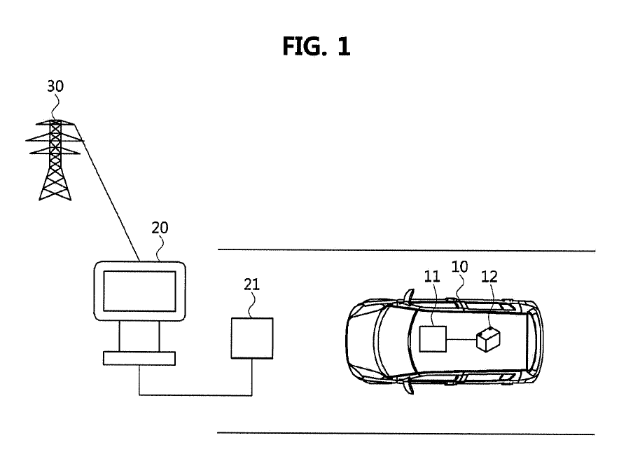

FIG. 1 is a conceptual diagram illustrating a concept of a wireless power transfer (WPT) to which embodiments of the present disclosure are applied.

As shown in FIG. 1, a WPT may be performed by at least one component of an electric vehicle (EV) 10 and a charging station 20, and may be used for wirelessly transferring power to the EV 10.

Here, the EV 10 may be usually defined as a vehicle supplying an electric power stored in a rechargeable energy storage including a battery 12 as an energy source of an electric motor which is a power train system of the EV 10.

However, the EV 10 according to embodiments of the present disclosure may include a hybrid electric vehicle (HEV) having an electric motor and an internal combustion engine together, and may include not only an automobile but also a motorcycle, a cart, a scooter, and an electric bicycle.

Also, the EV 10 may include a power reception pad 11 including a reception coil for charging the battery 12 wirelessly and may include a plug connection for conductively charging the battery 12. Here, the EV 10 configured for conductively charging the battery 12 may be referred to as a plug-in electric vehicle (PEV).

Here, the charging station 20 may be connected to a power grid 30 or a power backbone, and may provide an alternating current (AC) power or a direct current (DC) power to a power transmission pad 21 including a transmission coil through a power link.

Also, the charging station 20 may communicate with an infrastructure management system or an infrastructure server that manages the power grid 30 or a power network through wired/wireless communications, and performs wireless communications with the EV 10.

Here, the wireless communications may be Bluetooth, Zigbee, cellular, wireless local area network (WLAN), or the like.

Also, for example, the charging station 20 may be located at various places including a parking area attached to the owner's house of the EV 10, a parking area for charging an EV at a gas station, a parking area at a shopping center or a workplace.

A process of wirelessly charging the battery 12 of the EV 10 may begin with first placing the power reception pad 11 of the EV 10 in an energy field generated by the power transmission pad 21, and making the reception coil and the transmission coil be interacted or coupled with each other. An electromotive force may be induced in the power reception pad 11 as a result of the interaction or coupling, and the battery 12 may be charged by the induced electromotive force.

The charging station 20 and the transmission pad 21 may be referred to as a ground assembly (GA) in whole or in part, where the GA may refer to the previously defined meaning.

All or part of the internal components and the reception pad 11 of the EV 10 may be referred to as a vehicle assembly (VA), in which the VA may refer to the previously defined meaning.

Here, the power transmission pad or the power reception pad may be configured to be non-polarized or polarized.

In a case that a pad is non-polarized, there is one pole in a center of the pad and an opposite pole in an external periphery. Here, a flux may be formed to exit from the center of the pad and return at all to external boundaries of the pad.

In a case that a pad is polarized, it may have a respective pole at either end portion of the pad. Here, a magnetic flux may be formed based on an orientation of the pad.

In the present disclosure, the transmission pad 21 or the reception pad 11 may collectively be referred to as a ‘wireless charging pad’.

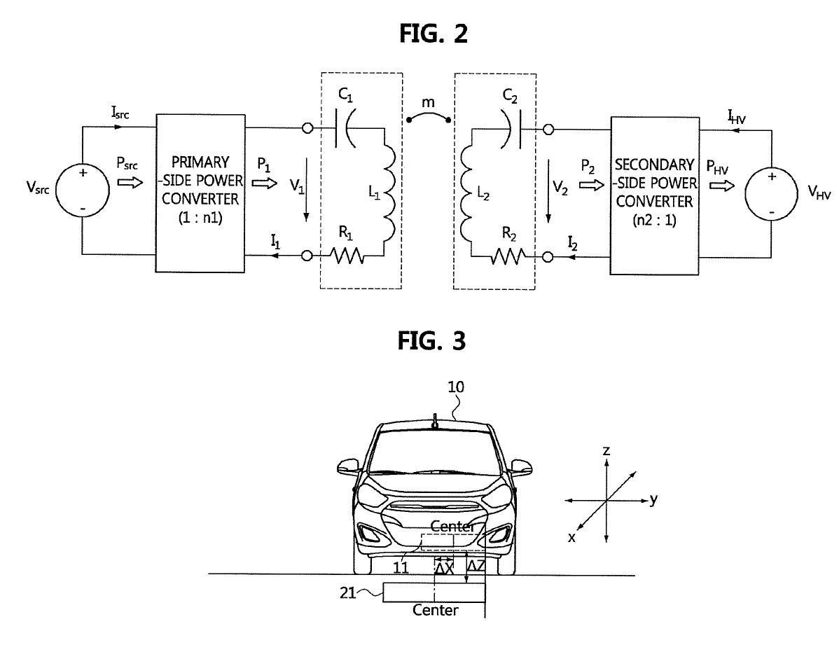

FIG. 2 is a conceptual diagram illustrating a WPT circuit according to embodiments of the present disclosure.

As shown in FIG. 2, a schematic configuration of a circuit in which a WPT is performed in an EV WPT system may be seen.

Here, the left side of FIG. 2 may be interpreted as expressing all or part of a power source V_{src} supplied from the power network, the charging station 20, and the transmission pad 21 in FIG. 1, and the right side of FIG. 2 may be interpreted as expressing all or part of the EV including the reception pad and the battery.

First, the left side circuit of FIG. 2 may provide an output power P_{src} corresponding to the power source V_{src} supplied from the power network to a primary-side power converter. The primary-side power converter may supply an output power P₁ converted from the output power P_{src} through frequency-converting and AC-to-DC/DC-to-AC converting to generate an electromagnetic field at a desired operating frequency in a transmission coil L₁.

Specifically, the primary-side power converter may include an AC/DC converter for converting the power P_{src} which is an AC power supplied from the power network into a DC power, and a low frequency (LF) converter for converting the DC power into an AC power having an operating frequency suitable for wireless charging. For example, the operating frequency for wireless charging may be determined to be within 80 to 90 kHz.

The power P₁ output from the primary-side power converter may be supplied again to a circuit including the transmission coil L₁, a first capacitor C₁ and a first resistor R₁. Here, a capacitance of the first capacitor C₁ may be determined as a value to have an operating frequency suitable for charging together with the transmission coil L₁. Here, the first resistor R₁ may represent a power loss occurred by the transmission coil L₁ and the first capacitor C₁.

Further, the transmission coil L₁ may be made to have electromagnetic coupling, which is defined by a coupling coefficient m, with the reception coil L₂ so that a power P₂ is transmitted, or the power P₂ is induced in the reception coil L₂. Therefore, the meaning of power transfer in the present disclosure may be used together with the meaning of power induction.

Still further, the power P₂ induced in or transferred to the reception coil L₂ may be provided to a secondary-side power converter. Here, a capacitance of a second capacitor C₂ may be determined as a value to have an operating frequency suitable for wireless charging together with the reception coil L₂, and a second resistor R₂ may represent a power loss occurred by the reception coil L₂ and the second capacitor C₂.

The secondary-side power converter may include an LF-to-DC converter that converts the supplied power P₂ of a specific operating frequency to a DC power having a voltage level suitable for the battery V_{HV} of the EV.

The electric power P_{HV} converted from the power P₂ supplied to the secondary-side power converter may be output, and the power P_{HV} may be used for charging the battery V_{HV} disposed in the EV. The right side circuit of FIG. 2 may further include a switch for selectively connecting or disconnecting the reception coil L₂ with the battery V_{HV}. Here, resonance frequencies of the transmission coil L₁ and the reception coil L₂ may be similar or identical to each other, and the reception coil L₂ may be positioned near the electromagnetic field generated by the transmission coil L₁.

The circuit of FIG. 2 should be understood as an illustrative circuit for WPT in the EV WPT system used for embodiments of the present disclosure, and is not limited to the circuit illustrated in FIG. 2.

On the other hand, since the power loss may increase as the transmission coil L₁ and the reception coil L₂ are located at a long distance, it may be an important factor to properly set the relative positions of the transmission coil L₁ and the reception coil L₂.

The transmission coil L₁ may be included in the transmission pad 21 in FIG. 1, and the reception coil L₂ may be included in the reception pad 11 in FIG. 1. Therefore, positioning between the transmission pad and the reception pad or positioning between the EV and the transmission pad will be described below with reference to the drawings.

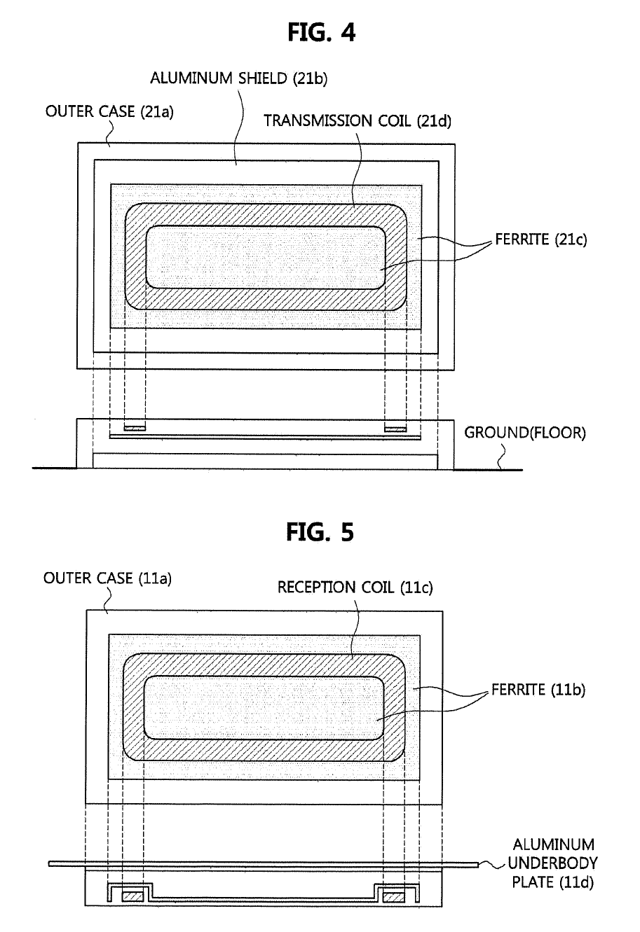

FIG. 3 is a conceptual diagram for explaining a concept of alignment in an EV WPT according to embodiments of the present disclosure.

As shown in FIG. 3, a method of aligning the power transmission pad 21 and the power reception pad 11 in the EV in FIG. 1 will be described. Here, a positional alignment may correspond to the alignment, which is the above-mentioned term, and thus may be defined as a positional alignment between the GA and the VA, but is not limited to the alignment of the transmission pad and the reception pad.

Although the transmission pad 21 is illustrated as positioned below a ground surface as shown in FIG. 3, the transmission pad 21 may also be positioned on the ground surface, or positioned such that a top portion surface of the transmission pad 21 is exposed below the ground surface.

The reception pad 11 of the EV may be defined by different categories according to its heights (defined in the z-direction) measured from the ground surface. For example, a class 1 for reception pads having a height of 100-150 millimeters (mm) from the ground surface, a class 2 for reception pads having a height of 140-210 mm, and a class 3 for reception pads having a height of 170-250 mm may be defined. Here, the reception pad may support a part of the above-described classes 1 to 3. For example, only the class 1 may be supported according to the type of the reception pad 11, or the class 1 and 2 may be supported according to the type of the reception pad 11.

The height of the reception pad measured from the ground surface may correspond to the previously defined term “vehicle magnetic ground clearance”.

Further, the position of the power transmission pad 21 in the height direction (i.e., defined in the z-direction) may be determined to be located between the maximum class and the minimum class supported by the power reception pad 11. For example, when the reception pad supports only the class 1 and 2, the position of the power transmission pad 21 may be determined between 100 and 210 mm with respect to the power reception pad 11.

Still further, a gap between the center of the power transmission pad 21 and the center of the power reception pad 11 may be determined to be located within the limits of the horizontal and vertical directions (defined in the x- and y-directions). For example, it may be determined to be located within ±75 mm in the horizontal direction (defined in the x-direction), and within ±100 mm in the vertical direction (defined in the y-direction).

Here, the relative positions of the power transmission pad 21 and the power reception pad 11 may be varied in accordance with their experimental results, and the numerical values should be understood as exemplary.

Although the alignment between the pads is described on the assumption that each of the transmission pad 21 and the reception pad 11 includes a coil, more specifically, the alignment between the pads may mean the alignment between the transmission coil (or GA coil) and the reception coil (or VA coil) which are respectively included in the transmission pad 21 and the reception pad 11.

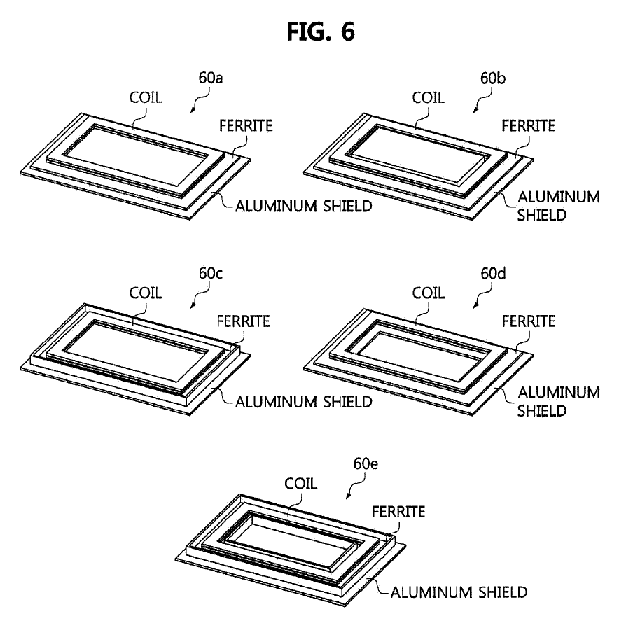

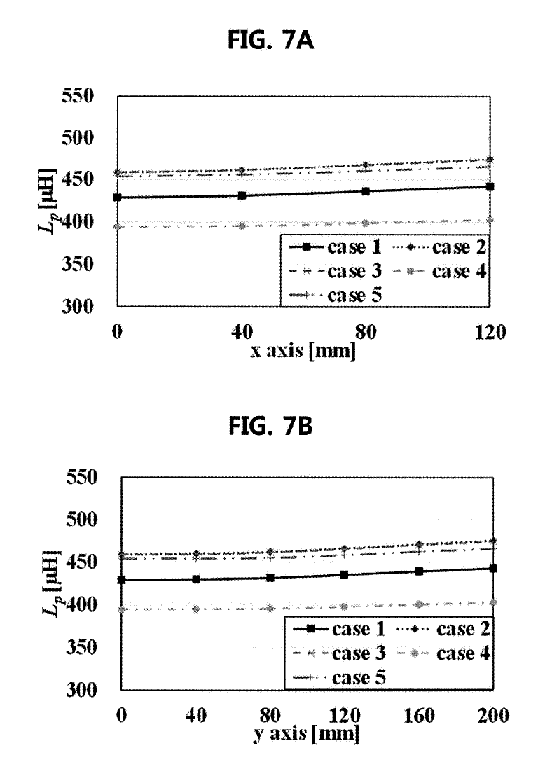

FIG. 4 is a diagram illustrating a cross-sectional view and an elevation view of a transmission pad according to an embodiment of the present disclosure, and FIG. 5 is a diagram illustrating a cross-sectional view and an elevation view of a reception pad according to an embodiment of the present disclosure.

Referring to FIG. 4, a transmission pad may comprise an outer case 21a forming an outer shape, an aluminum shield 21b provided in a flat plate shape inside the outer case 21a, a plate type ferrite 21c disposed on an upper part of the aluminum shield 21b, and a transmission coil 21d disposed on an upper part of the plate type ferrite 21c. Here, the upper part may refer to upward direction with respect to a ground on which the transmission pad is installed.

Here, ferrite, which is a material used for the plate type ferrite 21c, is a magnetic material including iron oxide, which can reduce magnetic resistance and assist the flow of magnetic flux to transmit and receive wireless power.

Referring to FIG. 5, a reception pad may comprise an aluminum underbody plate 11d disposed on a lower part of the vehicle, an outer case 11a disposed on a lower part of the aluminum underbody plate 11d, a plate type ferrite 11b disposed inside the outer case 11a, and a reception, coil 11c disposed inside the outer case 11a and disposed on a lower part of the plate type ferrite 11b (i.e., ground direction when the reception pad is installed under the vehicle). In this case, the central portion of the plate type ferrite 11b may protrude so as to face the inner side of the reception coil 11c. Also, the outer periphery of the plate type ferrite 11b may be in form of a wall surrounding the outer side of the reception coil 11c.

Compared with the transmission pad of FIG. 4, the reception pad of FIG. 5 may not include the aluminum shield 21b. Meanwhile, the structures of the transmission pad and the reception pad may be determined as shown in Table 1 below.

TABLE 1

| | Transmission pad | Reception pad |
|---|---|---|
| Outer case size | 660 × 500 (mm²) | 250 × 250 (mm²) |
| Aluminum shield | 640 × 480 × 2 (mm³) | 250 × 250 × 3 (mm³) |
| Aluminum | Not applicable | 800 × 800 × 2 (mm³) |
| underbody plate | | |
| Ferrite | 600 × 440 × 6 (mm³) | 224 × 224 × 3 (mm³) |
| Ferrite shape | Plate type | U type with protruding |
| | | central portion |
| Coil outer diameter | 540 × 380 (mm²) | 232 × 232 (mm²) |
| Coil inner diameter | 400 × 240 (mm²) | 160 × 160 (mm²) |
| Coil width | 10 (mm) (max.) | 7 (mm) (max) |
| Coil width ratio | 0.167/0.117 | 0.149/0.149 |
| (x/y) | | |
| Ground - Al | 14 (mm) | |
| Al top - Fe top | 22 (mm) | |
| Fe top - Coil top | 15 (mm) | |
| Al top - Fe bottom | | 1 (mm) |

Referring to Table 1, the detailed structures of the transmission pad and the reception pad may be confirmed. Specifically, in Table 1, elements for determining the structure of the transmission pad may include an outer case size (external size), an aluminum shield size, an aluminum underbody plate size, a ferrite size, a ferrite shape, an outer diameter of a coil, an inner diameter of a coil, a width of a coil, a width ratio of a coil, a distance between a ground and the aluminum shield (i.e., ‘Ground-Al’), a distance between an upper part (top) of the aluminum shield and an upper part (top) of the ferrite (i.e., ‘Al to—Fe top’), a distance between the upper part (top) of the ferrite and an upper part (top) of the coil (i.e., ‘Fe top—Coil top’), and a distance between an upper part (top) of the aluminum shield and a lower part (bottom) of the ferrite (i.e., ‘Al top—Fe bottom’).

Meanwhile, depending on the structure of the ferrite included in the transmission pad and the reception pad, the efficiency with which the wireless power is transferred from the transmission pad to the reception pad may vary, and the degree of electromagnetic interference (EMI) may also vary. Therefore, the present disclosure proposes ferrite structures capable of reducing EMI while maintaining maximum power transfer efficiency.

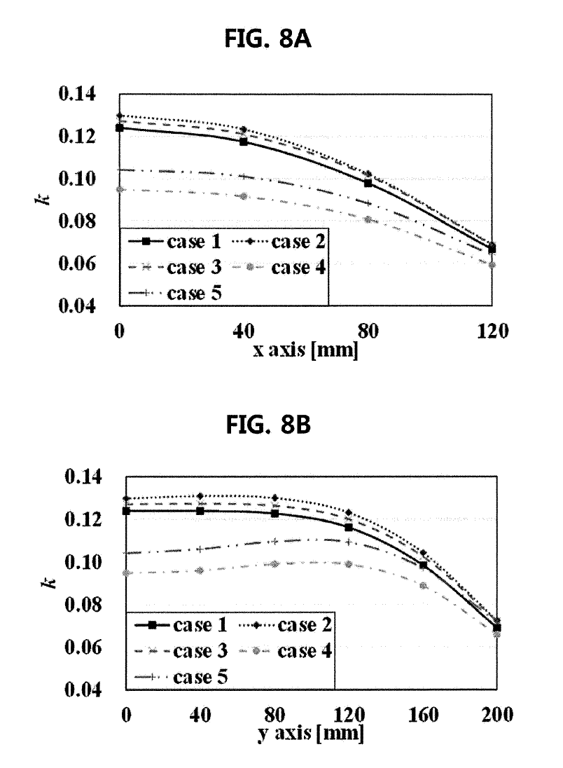

FIG. 6 is an exemplary view illustrating ferrite structures applicable to a transmission pad and a reception pad according to embodiments of the present disclosure.

Referring to FIG. 6, various embodiments of ferrite structures that can be applied to a transmission pad or a reception pad may be identified. FIG. 6 illustrates structures of the ferrite plate applied to the transmission pad. The transmission pad may include the aluminum shield 21b, the plate type ferrite 21c, and the coil 21d as shown in FIG. 4. However, the ferrite structures are not limited to those for the transmission pad and may also be applied to the reception pad.

First, the first embodiment (60a) shows a structure in which a plate-shaped ferrite is disposed on a flat aluminum shield, and this structure may be the simplest form (referred to as ‘basic type’).

The second embodiment (60b) shows a ferrite structure formed in a plate shape, and the ferrite structure has a central portion (or referred to as a ‘first ferrite member’) protruding to one side of the pad (e.g., direction facing a counterpart pad (i.e., reception pad or transmission pad)) so as to face the inner surface of the coil. In this case, the central portion of the ferrite may occupy a portion inside the region defined by the inner surface of the coil.

The third embodiment (60c) shows a ferrite structure formed in a plate shape, and the outer portion of the ferrite (or referred to as a ‘second ferrite member’) may have a wall shape so as to surround the outer surface of the coil. In this case, the outer portion of the ferrite may occupy a portion outside the region defined by the outer surface of the coil.

The fourth embodiment (60d) shows a ferrite structure formed in a plate shape, and the central portion of the ferrite may have a groove formed by removing all or a part thereof. That is, the central portion of the ferrite may be a structure in which only a part of the region adjacent to the inner surface of the coil is left and the rest is removed.

The fifth embodiment (60e) shows a ferrite structure formed in a plate shape, and a central portion of the ferrite may have a groove, and may have a wall shape surrounded by the inner surface of the coil between the boundary of the groove and the inner surface of the coil. Further, the outer portion of the ferrite may be in the form of a wall surrounding the outer surface of the coil.

Therefore, the ferrite structures according to the first embodiment (60a) to the fifth embodiment (60e) are all based on a planar ferrite structure. In this case, the coils which the ferrite surrounds or on which the ferrite is installed may be installed as having a uniform spacing with the ferrite so that the magnetic flux can flow easily.

Hereinafter, results of experiments on the electromagnetic characteristics of the first to sixth embodiments (60a to 60e) will be described, and an optimum ferrite structure applicable to a transmission pad or a reception pad is proposed.

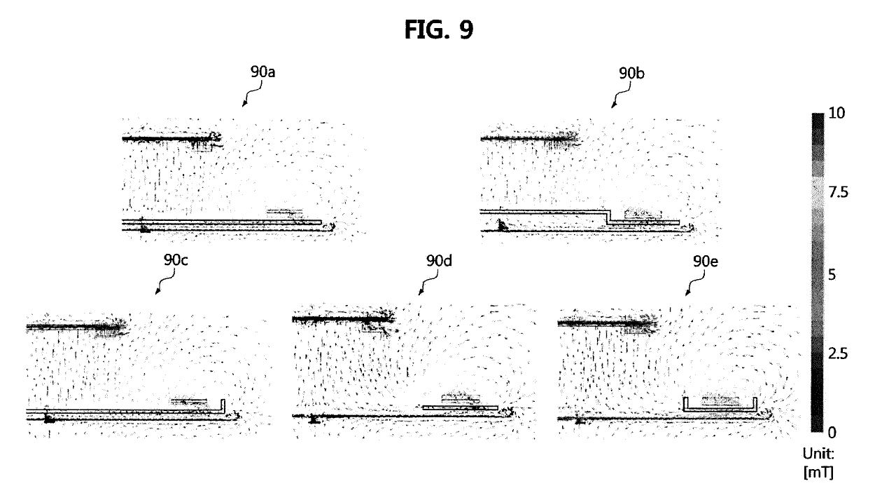

FIG. 7A is a graph illustrating a change in magnetic inductance due to x-axis separation between a transmission pad and a reception pad to which various ferrite structures according to embodiments of the present disclosure are applied, and FIG. 7B is a graph illustrating a change in magnetic inductance due to y-axis separation between a transmission pad and a reception pad to which various ferrite structures according to embodiments of the present disclosure are applied.

In FIGS. 7A and 7B, the x-axis separation or the y-axis separation may refer to the spacing between the transmission pad and the reception pad in the x-axis direction or the y-axis direction in the coordinate system according to FIG. 3. Also, when analyzing the magnetic inductance change, a vertical distance (z-axis spacing) of 100 mm is applied. The plate type ferrite is applied to the reception pad, and the basic structures except the ferrite structures of the transmission pad and the reception pad follow the detailed specification according to the above-described Table 1. Also, cases 1 to 5 correspond to the first to fifth embodiments according to FIG. 6, respectively.

Referring to FIGS. 7A and 7B, it was confirmed that the magnetic inductance of the transmission pad increases as the x-axis separation distance or the y-axis separation distance increases. This can be attributed to a decrease in the influence of the aluminum shield of the reception pad due to the increase in the separation distance. Particularly, in comparison with the first embodiment having the general plate type ferrite structure, it was confirmed that the highest magnetic inductance is measured in the second and third embodiments of the ferrite structure, and the magnetic inductance also rises to a high level according to the increase of the x-axis separation distance or the y-axis separation distance. Also, the ferrite structure according to the fifth embodiment has a relatively high magnetic inductance measured in comparison with the first embodiment. However, the ferrite structure according to the fourth embodiment has a relatively low magnetic inductance as compared with the first embodiment.

Therefore, in the case where the central portion of the ferrite is protruded to face the inner surface of the coil (i.e., the second embodiment) and/or in the case where the outer portion of the ferrite surrounds the outer surface of the coil (i.e., the third embodiment or the fifth embodiment), it was confirmed that the magnetic inductance is improved more than the basic type (i.e., the first embodiment). On the other hand, it was confirmed that the magnetic inductance is relatively reduced compared to the basic type in the case where the all or part of the central portion of the ferrite is removed to form a groove (i.e., the fourth embodiment) instead of the protruding shape.

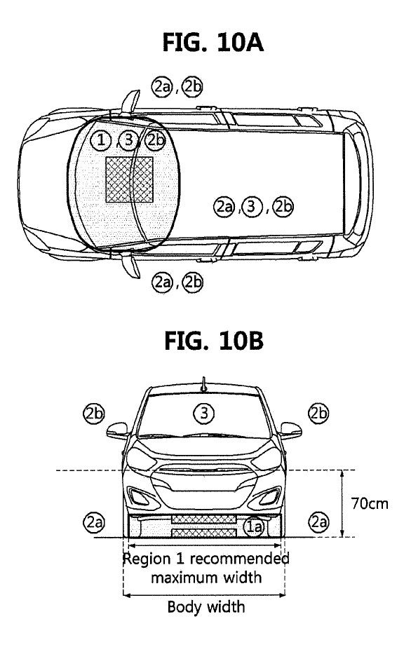

FIG. 8A is a graph illustrating a change in coupling coefficient due to x-axis separation between a transmission pad and a reception pad to which various ferrite structures according to embodiments of the present disclosure are applied, and FIG. 8B is a graph illustrating a change in coupling coefficient due to y-axis separation between a transmission pad and a reception pad to which various ferrite structures according to embodiments of the present disclosure are applied.

The experimental environment in FIGS. 8A and 8B is configured to be the same as the experimental environment in FIGS. 7A and 7B.

Referring to FIGS. 8A and 8B, it was confirmed that the coupling coefficient decreases for all the ferrite structures as the x-axis separation distance or the y-axis separation distance increases. Particularly, the highest coupling coefficient was measured in the ferrite structure of the second embodiment. Also, it was confirmed that the ferrite structure of the third embodiment has a relatively high coupling coefficient, though not a large difference, as compared with the ferrite structure of the first embodiment. Further, in the ferrite structures according to the fourth and fifth embodiments, the coupling coefficient was measured to be relatively low as compared with the first embodiment.

Therefore, in the case where the central portion of the ferrite is protruded to face the inner surface of the coil (i.e., the second embodiment) and/or in the case where the outer portion of the ferrite has a wall shape surrounding the outer surface of the coil (i.e., the third embodiment), it was confirmed that the coupling coefficient is improved more than the basic type (i.e., the first embodiment). On the other hand, it was confirmed that the coupling coefficient is relatively reduced compared to the basic type in the case where the all or part of the central portion of the ferrite is removed to form a groove (i.e., the fourth embodiment or the fifth embodiment) instead of the protruding shape.

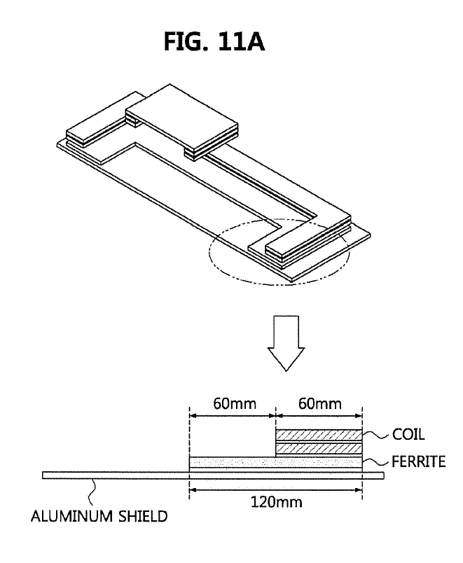

FIG. 9 is an exemplary view illustrating magnetic flux density distributions formed between a transmission pad and a reception pad to which various ferrite structures according to embodiments of the present disclosure are applied.

Referring to FIG. 9, a first distribution map 90a is a magnetic flux density distribution measured using a transmission pad according to the first embodiment 60a of FIG. 6, a second distribution map 90b is a magnetic flux density distribution measured using a transmission pad according to the second embodiment 60b of FIG. 6, a third distribution map 90c is a magnetic flux density distribution measured using a transmission pad according to the third embodiment 60c of FIG. 6, a fourth distribution map 90d is a magnetic flux density distribution measured using a transmission pad according to the fourth embodiment 60d of FIG. 6, and a fifth distribution map 90e is a magnetic flux density distribution measured using a transmission pad according to the fifth embodiment 60e of FIG. 6. Here, the shade of the magnetic flux density distribution shows a magnetic flux density between 0 mT and 10 mT.

When the second distribution map 90b to the fifth distribution map 90e are compared with the first distribution map 90a measured using the transmission pad having the ferrite of the basic planar structure, it can be seen that the magnetic flux density varies depending on whether or not the ferrite is present. Particularly, in the case where the central portion or outer portion of the ferrite has a protruding shape or a wall shape (i.e., the second embodiment, the third embodiment, and the fifth embodiment), it can be confirmed that the magnetic fluxes are distributed much in the protruded part because the magnetic resistance is small in such the protruded part.

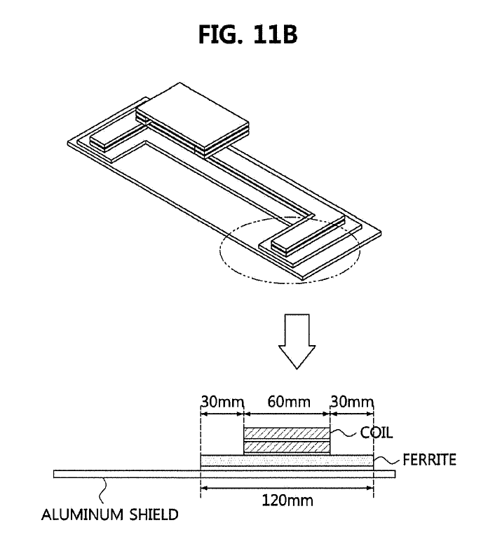

FIGS. 10A and 10B are diagrams illustrating an experimental environment in which EMI is evaluated using a transmission pad to which various ferrite structures are applied according to embodiments of the present disclosure.

Referring to FIG. 10A, physical regions for measuring the magnetic flux density viewed from the top of the vehicle can be identified. Also, referring to FIG. 10B, physical regions for measuring the magnetic flux density viewed from the front of the vehicle can be identified. Specifically, a region 2a may be, as a region around the vehicle, a region less than 70 cm from the ground. Also, a region 2b may be, as a region around the vehicle, a region not less than 70 cm from the ground. Also, a region 3 may be a region inside the vehicle.

The results of magnetic flux density measurement when the transmission pads having various ferrite structures according to FIG. 6 are applied to the regions 2a, 2b and 3 specified with reference to FIGS. 10A and 10B are shown in Table 2 below.

TABLE 2

Structure

| Region | First | Second | Third | Fourth | Fifth |
|---|---|---|---|---|---|
| 2a | 4.312 | 4.462 | 4.571 | 3.790 | 4.401 |
| 2b | 1.831 | 1.896 | 1.954 | 1.631 | 1.870 |
| 3 | 40.181 | 43.332 | 41.802 | 34.926 | 39.565 |

Referring to Table 2, when the power of 3.3 kW, which is the maximum load condition, is transferred, the magnetic flux density measurement results can be confirmed in the regions 2a, 2b and 3 specified in FIGS. 10A and 10B. Since the measurement regions 2a, 2b, and 3 correspond to the regions that need to ensure the safety of the user, the wireless charging standard J2954 provides guidelines for exposure of the electric and magnetic field (EMF). Therefore, referring to the results of Table 2, it can be determined that the fourth embodiment has the lowest magnetic flux density and thus the safety is excellent. That is, it can be explained that the fourth embodiment has the best EMI characteristic.

Hereinafter, the ferrite structure according to the fourth embodiment (i.e., the structure in which the central portion of the ferrite is grooved) having the best EMI characteristic is tested based on the relative positions of the ferrite and the coil, and the optimum ferrite structure is proposed.

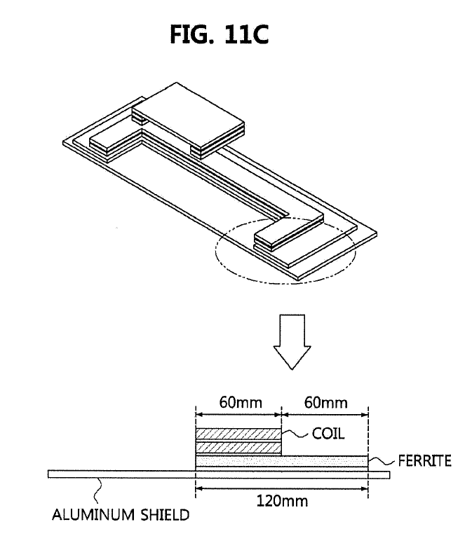

FIGS. 11A to 11C are diagrams illustrating ferrite structures obtained by subdividing the ferrite structure according to the fourth embodiment of FIG. 6 by the relative positions of the coils and the ferrite. Here, as an example, the width of the coil may be 60 mm, the number of turns of the coil may be 20, and the width of the ferrite having the groove at the center may be 120 mm.

Referring to FIG. 11A, in a wireless charging pad (fourth embodiment of FIG. 6) including the plate type ferrite with a groove in the central portion, the coil is arranged so that the outer surface of the coil and the outer surface of the plate type ferrite are on the same vertical plane.

Referring to FIG. 11B, in a wireless charging pad (fourth embodiment of FIG. 6) including the plate type ferrite with a groove in the central portion, the coil is arranged so as have the uniform spacing (e.g., 30 mm) with the outer surface of the plate type ferrite and the boundary of the groove.

Referring to FIG. 11C, in a wireless charging pad (fourth embodiment of FIG. 6) including the plate type ferrite with a groove in the central portion, the coil is arranged so that the inner surface of the coil and the boundary of the groove are on the same vertical plane.

Hereinafter, a wireless charging pad having the structure according to FIG. 11A will be referred to as Embodiment 4-1, a wireless charging pad having the structure according to FIG. 11B will be referred to as Embodiment 4-2, and a wireless charging pad having the structure according to FIG. 11C will be referred to as Embodiment 4-3.

The electromagnetic characteristics were tested using the wireless charging pads according to Embodiments 4-1, 4-2, and 4-3 as the transmission pad, as shown in Tables 3 and 4 below. Here, the reception pad has a plate type ferrite, and the basic specifications except for the ferrite structures of the transmission pad and the reception pad follow the detailed specifications according to Table 1 described above.

TABLE 3

| | Structure | | |
|---|---|---|---|
| Measurement | 4-1 | 4-2 | 4-3 |
| Lₚ (μH) | 409.47 | 363.47 | 281.54 |
| Lₛ (μH) | 151.56 | 145.11 | 152.75 |
| k | 0.0792 | 0.0793 | 0.1153 |

Referring to Table 3, when the x-axis and y-axis separation distance and the z-axis separation distance according to FIG. 3 are set to 100 mm, the inductance characteristics Lₚ and Lₛ and the coupling coefficient k of the wireless charging pad according to Embodiments 4-1 to 4-3 can be confirmed. Specifically, it can be confirmed that the wireless charging pad according to Embodiment 4-3 has the best coupling coefficient k, but the magnetic inductance Lₚ of the wireless charging pad according to Embodiment 4-3 is the lowest.

TABLE 4

| | Structure | | |
|---|---|---|---|
| Region | 4-1 | 4-2 | 4-3 |
| 2a | 5.107 | 4.312 | 3.190 |
| 2b | 2.018 | 1.831 | 1.323 |
| 3 | 45.001 | 40.181 | 31.916 |

Referring to Table 4, it can be seen that the magnetic flux densities (unit:μT) of the wireless charging pad according to Embodiments 4-1 to 4-3 are measured under the experimental position condition shown in FIG. 10. Specifically, it can be seen that the best EMI characteristic is obtained because the wireless charging pad according to Embodiment 4-3 has the smallest magnetic flux density in all the regions 2a, 2b and 3.

However, since the wireless charging pad according to Embodiment 4-3 is superior in the coupling coefficient and the EMI characteristic but has a small magnetic inductance, a larger current is required to generate the same amount of magnetic flux as other types of wireless charging pads. Therefore, in the wireless charging pad according to Embodiment 4-3, the power loss may increase due to the larger current, so that the efficiency may decrease.

Also, since the area occupied by the coil is the smallest in the wireless charging pad according to Embodiment 4-3, the coupling coefficient may decrease rapidly when the x-axis and/or the y-axis separation occurs. Accordingly, it may become difficult to meet the x-axis separation distance of 75 mm and the y-axis separation distance of 100 mm, which are separation conditions that need to be satisfied in the EV WPT.

Considering the advantages and disadvantages described above, the wireless charging pad satisfying the x-axis and/or y-axis separation conditions and having appropriate EMI characteristics may be the wireless charging pad according to Embodiment 4-2.

The methods according to embodiments of the present disclosure may be implemented as program instructions executable by a variety of computers and recorded on a computer readable medium. The computer readable medium may include a program to instruction, a data file, a data structure, or a combination thereof. The program instructions recorded on the computer readable medium may be designed and configured specifically for an exemplary embodiment of the present disclosure or can be publicly known and available to those who are skilled in the field of computer software.

Examples of the computer readable medium may include a hardware device including ROM, RAM, and flash memory, which are configured to store and execute the program instructions. Examples of the program instructions include machine codes made by, for example, a compiler, as well as high-level language codes executable by a computer, using an interpreter. The above exemplary hardware device can be configured to operate as at least one software module to perform the operation of the present disclosure, and vice versa. Also, the above-described method or apparatus may be implemented by combining all or a part of the structure or functions, or may be implemented separately.

While the embodiments of the present disclosure and their advantages have been described in detail, it should be understood that various changes, substitutions, and alterations may be made herein without departing from the scope of the present disclosure.

What is claimed is:

1. A wireless charging pad for transferring wireless power to an electric vehicle (EV), the wireless charging pad comprising:
a plate type ferrite; and
a coil disposed on an upper part of the plate type ferrite,
wherein the plate type ferrite comprises a first ferrite member occupying an inside of a region defined by an inner surface of the coil and a second ferrite member occupying an outside of a region defined by an outer surface of the coil, and
wherein the first ferrite member comprises a protruding portion facing the inner surface of the coil.

2. The wireless charging pad according to claim 1, further comprising a flat plate type aluminum shield disposed in a lower part of the plate type ferrite.

3. The wireless charging pad according to claim 1, wherein the coil has a uniform spacing with the protruding portion of the first ferrite member and an outer surface of the second ferrite member.

4. A wireless charging pad for transferring wireless power to an electric vehicle (EV), the wireless charging pad comprising:
a plate type ferrite; and
a coil disposed on an upper part of the plate type ferrite,
wherein the plate type ferrite comprises a first ferrite member occupying an inside of a region defined by an inner surface of the coil and a second ferrite member occupying an outside of a region defined by an outer surface of the coil, and
wherein the second ferrite member has a wall shape surrounding the outer surface of the coil.

5. The wireless charging pad according to claim 4, wherein a width between the inner surface of the coil and the outer surface of the coil is 60 millimeters.

6. A wireless charging pad for transferring wireless power to an electric vehicle (EV), the wireless charging pad comprising:
a plate type ferrite; and
a coil disposed on an upper part of the plate type ferrite,
wherein the plate type ferrite comprises a first ferrite member occupying an inside of a region defined by an inner surface of the coil and a second ferrite member occupying an outside of a region defined by an outer surface of the coil, and
wherein the first ferrite member comprises a groove at a central portion of the first ferrite member.

7. The wireless charging pad according to claim 6, wherein the first ferrite member has a wall shape surrounded by the inner surface of the coil in between a boundary of the groove and the inner surface of the coil.

8. The wireless charging pad according to claim 7, wherein the second ferrite member has a wall shape surrounding the outer surface of the coil.

9. The wireless charging pad according to claim 6, wherein the coil is arranged so that an outer surface of the plate type ferrite and the outer surface of the coil are on a same vertical plane.

10. The wireless charging pad according to claim 6, wherein the coil has a uniform spacing with an outer surface of the plate type ferrite and a boundary of the groove.

11. The wireless charging pad according to claim 6, wherein the coil is arranged so that a boundary of the groove and the inner surface of the coil are on a same vertical plane.

12. The wireless charging pad according to claim 6, wherein the wireless charging pad is a transmission pad for transferring wireless power to a reception pad equipped in the EV.

13. The wireless charging pad according to claim 6, further comprising a flat plate type aluminum shield disposed in a lower part of the plate type ferrite.

14. The wireless charging pad according to claim 6, wherein a width between the inner surface of the coil and the outer surface of the coil is 60 millimeters.
